(19) United States
(12) Patent Application Publication
(10) Pub. No.: US 2009/0058993 A1
(43) Pub. Date: Mar. 5, 2009

(54) CMOS STEREO CAMERA FOR OBTAINING THREE-DIMENSIONAL IMAGE

(75) Inventors: Byoung Su Lee, Jeol-Ianam-do (KR); Jun Ho Won, Seoul (KR)

Correspondence Address: CANTOR COLBURN, LLP, 20 Church Street, 22nd Floor, Hartford, CT, 06103, US

(73) Assignee: SILICONFILE TECHNOLOGIES INC., Seoul (KR)

(21) Appl. No.: 12/281,743

(22) PCT Filed: Feb. 7, 2007
(86) PCT No.: PCT/KR07/00644

§ 371 Date: Sep. 4, 2008

(30) Foreign Application Priority Data
Mar. 9, 2006 (KR) 10-2006-0022296

(51) Int. Cl. H04N 13/04; H04N 5/335

(52) U.S. Cl. 348/49; 348/308; 348/E13.001; 348/E05.091

(57) ABSTRACT

A CMOS stereo camera for obtaining a three-dimensional image, in which two CMOS image sensors having the same characteristics are disposed on a single semiconductor substrate, is provided. The CMOS image sensors have image planes which are located on the same plane by disposing the two CMOS image sensors on the same semiconductor substrate. A digital signal processor (DSP) for processing a three-dimensional image is disposed between the CMOS image sensors. Optical axes of the CMOS image sensors are parallel with each other and orthogonal to the image planes. Since optical devices formed on the CMOS image sensors can be manufactured through the same processes, distortion of the optical axes between the two CMOS image sensors can be minimized.

### BACKGROUND OF THE INVENTION

1. Field of the Invention

The present invention relates to a camera for obtaining a three-dimensional image, and more particularly, to a CMOS stereo camera for obtaining a three-dimensional image capable of easily acquiring three-dimensional information from the images obtained by using at least two CMOS image sensors.

2. Description of the Related Art

Conventional methods of obtaining three-dimensional information of an object include a method of using binocular disparity which is disparity between images obtained from left and right sides and a method of detecting distances to points of a three-dimensional object.

In the method of using the binocular disparity, two image sensors disposed in parallel with each other are used. Since the two image sensors views a three dimensional object in different directions, images obtained by the two image sensors are different from each other. Accordingly, distance information can be obtained by searching for the same point in the two images and comparing displacements of left and right images.

Since the aforementioned method uses two image sensors, the method is performed by using relatively simple devices. However, in order to search for the same point from the obtained two images, a large number of image processing operations are needed, and therefore, a large amount of calculation is needed.

On the other hand, in the method of measuring distances to points of the three-dimensional object, distance information of all the points of the three-dimensional object is accurately measured. However, complicate devices are needed, and the measuring speed is low.

In a more general method, distances are measured by irradiating the three-dimensional object with a laser beam having a grid pattern that is a net shape by using a laser pointer to obtain left and right images by using cameras arranged in parallel with each other.

In the aforementioned method, the same point is easily searched for between the two images. However, a pointer emitting a laser beam having a grid pattern are needed, in addition to the two cameras. The method cannot be performed in a general open air environment.

FIG. 1 illustrates a conventional example 100, in which three-dimensional information is obtained by comparing a left image with a right image.

Referring to FIG. 1, a point A in a three-dimensional space is located at a point A′ on a left image 115 passing through a left lens 110 and at a point A″ on a right image 125 passing through a right lens 120. Depth information of the point A can be obtained by comparing the two images 115 and 125 with each other.

However, in the aforementioned method, in order to search for the same point by comparing the images 115 and 125 with each other, a complicate calculation is required. In most cases, the depth information is obtained by extracting edges of the images and assuming that the edges are the same points. The process of processing images and the process of determining the same point are complicate and have high uncertainty. Accordingly, a large number of processes are needed for modifying the uncertainty.

FIG. 2 illustrates an example 200 of a conventional flow of extracting three-dimensional information;

Referring to FIG. 2, images obtained by two horizontally disposed cameras 210 and 220 are stored in image buffers 215 and 225 through a serial or parallel communication links 201. The images, which are respectively stored in the image buffers 215 and 225, are transmitted to a digital signal processor (DSP) 230. Finally, three dimensional information 240 is obtained by searching for the same point by comparing the images and calculating the depth information in the DSP 230.

However, the conventional method of extracting the three-dimensional information shown in FIG. 2 needs the image buffers 215 and 225. In addition, a delay in a processing speed may occur due to traffic which is caused by the serial or parallel communication links 201.

### SUMMARY OF THE INVENTION

The present invention provides a CMOS stereo camera for obtaining a three-dimensional image, in which three-dimensional image information is simply calculated, and a processing speed is high, the CMOS stereo camera being small.

According to an aspect of the present invention, there is provided a CMOS stereo camera for obtaining a three-dimensional image, the CMOS stereos camera comprising: left and right lenses which receives light from a point source of light on the same plane; left and right CMOS image sensors which are disposed on a single substrate under the left and right lenses; and a DSP (digital signal processor) which is formed between the left and right CMOS image sensors to extract three-dimensional information of the point source of light by receiving images from the left and right CMOS image sensors through data buses.

According to another aspect of the present invention, there is provided a CMOS stereo camera for obtaining a three-dimensional image, the CMOS stereo camera comprising: at least three lenses which receives light from a point source of light on the same plane; at least three CMOS image sensors which are disposed on a single substrate under the at least three lenses; and a DSP (digital signal processor) which is formed among the at least three CMOS image sensors to extract three-dimensional information of the point source of light by receiving images from the at least three CMOS image sensors through data buses.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional example in which three-dimensional information is extracted;

FIG. 2 illustrates an example of a conventional flow of extracting three-dimensional information;

FIG. 3 illustrates a cross sectional view and a top plan view of a CMOS stereo camera for obtaining a three-dimensional image according to an embodiment of the present invention;

FIG. 4 illustrates a geometric relation between image points on the image planes which are obtained from a spatial point by using the CMOS stereo camera shown in FIG. 3;

FIG. 5 illustrates left and right images of a point source of light in the CMOS stereo camera shown in FIG. 3; and

FIG. 6 illustrates a flow of extracting three-dimensional information in the CMOS stereo camera shown in FIG. 3.

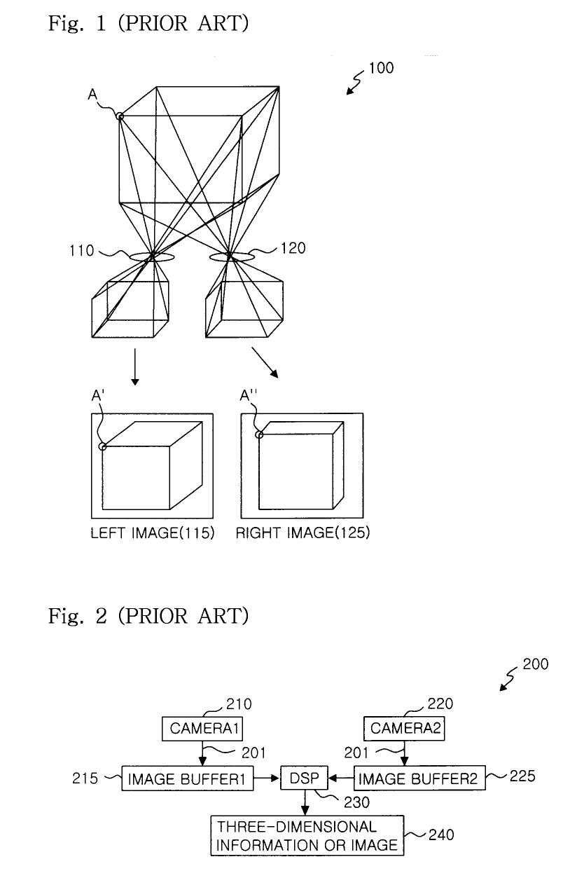

### DETAILED DESCRIPTION OF THE INVENTION

Hereinafter, the present invention will be described in detail with reference to accompanying drawings.

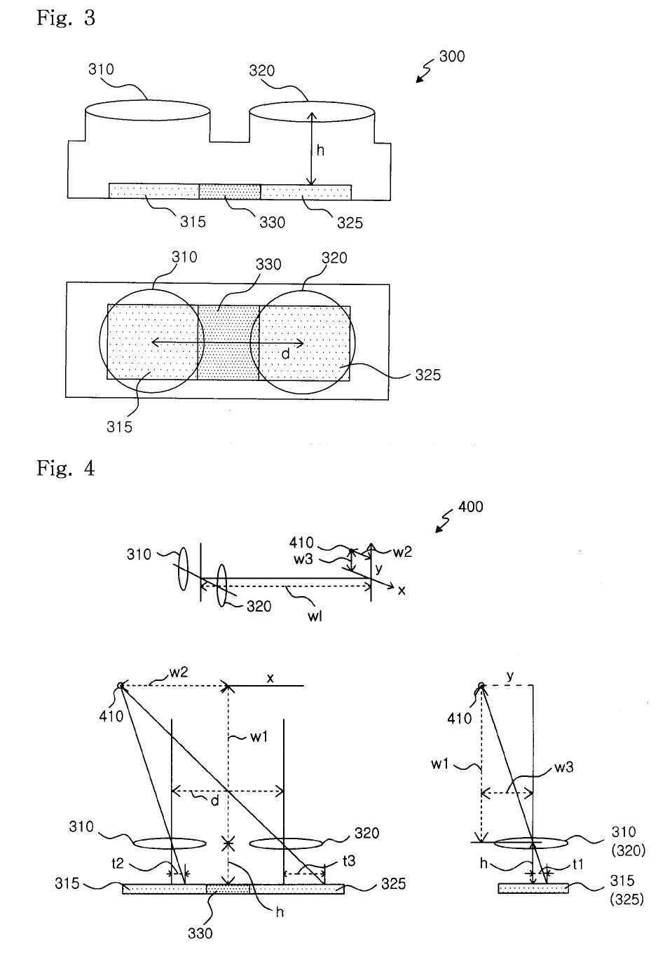

FIG. 3 illustrates a cross sectional view and a top plan view of a CMOS stereo camera for obtaining a three-dimensional image according to an embodiment of the present invention.

Referring to FIG. 3, a CMOS stereo camera 300 for obtaining a three-dimensional image according to the embodiment of the present invention includes two lenses 310 and 320, two CMOS image sensors 315 and 325, and a digital signal processor (DSP) 330. Here, the CMOS image sensors 315 and 325 and the DSP 330 are disposed on a single substrate. In addition, optical axes of the CMOS image sensors 315 and 325 are in parallel with each other and perpendicular to image planes.

The CMOS image sensors 315 and 325 are spaced apart from each other on the substrate. In addition, the CMOS image sensors 315 and 325 are disposed so that the distance between centers of the CMOS image sensors 315 and 325 is d. For convenience, the CMOS image sensor 315 disposed in the left side of FIG. 3 is referred to as a left CMOS image sensor, and the CMOS image sensor 325 disposed in the right side of FIG. 3 is referred to as a right CMOS image sensor.

The DSP 330 is disposed so as to extract three-dimensional information from images obtained from the CMOS image sensors 315 and 325. In order to effectively use a space, the DSP 330 may be disposed between the CMOS image sensors 315 and 325.

The lenses 310 and 320 are spaced apart from the image sensors 315 and 325 by a distance of h in a vertical direction. Specifically, the image planes formed by the CMOS image sensors 315 and 325 are spaced apart from planes of the lenses 310 and 320 by a distance of h in a vertical direction.

FIG. 4 illustrates a geometric relation 400 between image points on the image planes which are obtained from a spatial point by using the CMOS stereo camera 300 for obtaining a three-dimensional image shown in FIG. 3.

In FIG. 4, W1 indicates a vertical height from a plan of the left and right lenses 310 and 320 to a point source of light 410. W2 indicates a horizontal distance from a vertical axis passing through the center between the left and right CMOS image sensors 315 and 325 to the point source of light 410. W3 indicates horizontal distances from vertical axes passing through the centers of the CMOS image sensors 315 and 325 to the point source of light 410.

A horizontal distance d between the centers of the CMOS image sensors 315 and 325 and a vertical distance h between the image sensors and the lenses are related to a resolution of information on a measured depth. As the distance of d becomes larger as compared with the height of h, the resolution of depth information increases, and however, a depth of a distant object becomes indistinguishable. While, as the distance of d becomes smaller as compared with the height of h, the resolution of depth information decreases, and however, the depth of a distant object becomes distinguishable.

Light from the point source of light 410 disposed on X-Y plane is projected onto the left and light CMOS image sensors 315 and 325 by passing through the lenses 310 and 320, respectively.

A displacement t2 between the left image point and the center of the left CMOS image sensor 315 and a displacement t3 between the right image point and the center of the right CMOS image sensor 325 in the X axis direction vary depending on the distances from the centers of the lenses 310 and 320 to the point source of light 410. Accordingly, the depth information of the point source of light 410 can be obtained from the displacements t2 and t3.

Referring to FIG. 4, the depth information of a point in the three-dimensional space will be obtained in the following (it is assumed that t2<t3 in the example of FIG. 4).

$$\frac{t 3}{h} = \frac{W 2 + ( d / 2 )}{W 1} \\ \frac{t 2}{h} = \frac{W 2 - ( d / 2 )}{W 1} \\ \frac{t 1}{h} = \frac{W 3}{W 1} \qquad [ Equation 1 ]$$

W1, W2, and W3 can be obtained from Equation 1.

$$W 1 = \frac{h d}{t 3 - t 2} \\ W 2 = \frac{d}{2} \frac{t 2 + t 3}{t 3 - t 2} \\ W 3 = \frac{d t 1}{t 3 - t 2} \qquad [ Equation 2 ]$$

In the aforementioned arrangement, the displacement t1 of the image point of the point source of light 410 projected onto the Y axis is always the same with respect to the CMOS image sensors 315 and 325. The calculation needed for extracting the three-dimensional information of the object is simple due to the aforementioned feature.

FIG. 5 illustrates an example 500 of extracting the three-dimensional information. FIG. 5 illustrates a method of obtaining depth information of any line having the same t1 on the image sensors in a space, which is W1. The light departing from the point source of light is located at a point 515 on a left image plane 510 and at a point 525 on a right image plane 520. The heights t1 of the points 515 and 525 on the image planes are the same.

The spatial values W1, W2, and W3 can be obtained from the values t1, t2, and t3 of the image points by using Equations 1 and 2. Accordingly, the three-dimensional information can be obtained by using a method of searching for the same point by comparing the two lines having a specific value of t1 obtained from the image sensors with each other.

Accordingly, the calculation amount is sharply reduced with relatively low uncertainty as compared with the conventional method of searching for the same point by comparing the entire left and right images used for obtaining the three-dimensional depth information. In addition, the uncertainty of the depth included in the example can be easily modified by the depth information of neighboring points.

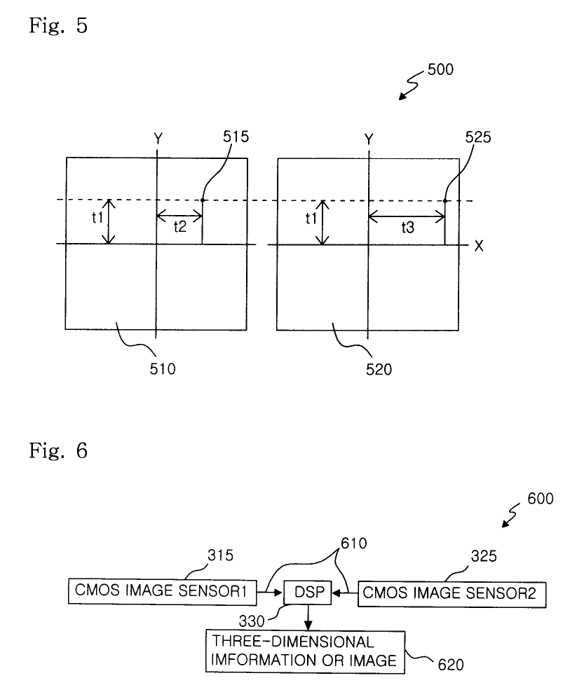

FIG. 6 illustrates an example 600 of a flow of extracting three-dimensional information in the CMOS stereo camera 300 for obtaining a three-dimensional image shown in FIG. 3.

Referring to FIG. 6, the CMOS image sensors 315 and 325 are connected to the DSP 330 for extracting the three-dimensional information through data buses 610. Three-dimensional information 620 is extracted by the DSP 330. Accordingly, unlike the conventional technique, the image buffers 215 and 225 of FIG. 2 are not needed. In addition, there is no delay in a processing speed due to traffic which is caused by the serial or parallel communication links 201 of FIG. 2.

In addition, the image information of the CMOS image sensors 315 and 325 is processed in units of several lines so as to interpolate the information. For example, in case of VGA, an image includes 640×480 pixels. The image processing operation such as the interpolation process and the like is performed by using several lines having 640 pieces of data.

Since the image processing operation is performed by using five to eight lines, there can be used the method of extracting three-dimensional information of a line from the DSP 330 by using data of several lines of the left and right CMOS image sensors 315 and 325, in which displacements t1 of image points of the two CMOS image sensors are the same with respect to any axis. Accordingly, the data is immediately processed without a delay, and therefore, an image processing speed is high.

Specifically, the three-dimensional information is easily extracted by using the method of searching for the same point by using data of several lines of the left and right CMOS image sensors 315 and 325, which have the same image point, and obtaining the depth information, as compared with the method of searching for the same point by using the entire left and right images.

Up to now, an example including two lenses and two CMOS image sensors formed on a single substrate is explained. However, the same result can be obtained in another example including three or more lenses and three or more CMOS image sensors corresponding to the lenses, which are formed on a single substrate.

As described above, a CMOS stereo camera for obtaining a three-dimensional image according to an embodiment of the present invention may have a small size by disposing at least two CMOS image sensors on the same plane of a single substrate and disposing a DSP for extracting three-dimensional information between the two or more CMOS image sensors. The CMOS stereo camera simply calculates the three-dimensional information by extracting the three-dimensional information in units of line. Accordingly, the CMOS stereo camera has a high processing speed.

In addition, since the CMOS stereo camera for obtaining a three-dimensional image according to an embodiment of the present invention does not need additional devices such as image buffers, a low-price three-dimensional image sensor can be embodied.

What is claimed is:

1. A CMOS stereo camera for obtaining a three-dimensional image, the CMOS stereos camera comprising:
left and right lenses which receives light from a point source of light on the same plane;
left and right CMOS image sensors which are disposed on a single substrate under the left and right lenses; and
a DSP (digital signal processor) which is formed between the left and right CMOS image sensors to extract three-dimensional information of the point source of light by receiving images from the left and right CMOS image sensors through data buses.

2. The CMOS stereo camera according to claim 1, wherein the three-dimensional information is obtained by calculating a height of the point source of light by using displacements of image points of the left and right CMOS image sensors obtained by allowing light from the point source of light to form images on the left and right CMOS image sensors by passing through the left and right lenses.

3. The CMOS stereo camera according to claim 1, wherein the three-dimensional information is extracted in units of line of the left and right CMOS image sensors.

4. The CMOS stereo camera according to claim 3, wherein the three-dimensional information is extracted by using a plurality of lines in which displacements of image points of the left and right CMOS image sensors are the same with respect to any axis.

5. The CMOS stereo camera according to claim 4, wherein the number of the plurality of lines ranges from five to eight.

6. A CMOS stereo camera for obtaining a three-dimensional image, the CMOS stereo camera comprising:
at least three lenses which receives light from a point source of light on the same plane;
at least three CMOS image sensors which are disposed on a single substrate under the at least three lenses; and
a DSP (digital signal processor) which is formed among the at least three CMOS image sensors to extract three-dimensional information of the point source of light by receiving images from the at least three CMOS image sensors through data buses.

7. The CMOS stereo camera according to claim 6, wherein the three-dimensional information is obtained by calculating a height of the point source of light by using displacements of image points of the at least three CMOS image sensors obtained by allowing light from the point source of light to form images on the at least three CMOS image sensors by passing through the at least three lenses.

8. The CMOS stereo camera according to claim 6, wherein the three-dimensional information is extracted in units of line of the at least three CMOS image sensors.

9. The CMOS stereo camera according to claim 8, wherein the three-dimensional information is extracted by using a plurality of lines in which displacements of image points of the at least three CMOS image sensors are the same with respect to any axis.

10. The CMOS stereo camera according to claim 9, wherein the number of the plurality of lines ranges from five to eight.
